(19) United States
(12) Patent Application Publication
(10) Pub. No.: US 2008/0123278 A1
(43) Pub. Date: May 29, 2008

(54) SLOT AVAILABILITY INDICATION SYSTEM AND METHOD FOR INDICATING SLOT AVAILABILITY

(75) Inventors: Michael A. Curnalia, Tucson, AZ (US); Rezaul S. Islam, Tucson, AZ (US); Gregg S. Lucas, Tucson, AZ (US); Koji Nakase, Kamakura (JP)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/556,558

(22) Filed: Nov. 3, 2006

(51) Int. Cl. G06F 1/16

(52) U.S. Cl. 361/685; 340/679

(57) ABSTRACT

Disclosed is a slot availability indication system including a RAID, at least one disk tray defining a first slot, second slot, and third slot, the first, second, and third slots being configured to contain a drive and being associated with the RAID, a RAID light indicator, a first, second, and third disk activity light indicator, and a first, second, and third disk availability light indicator disposed on the trays, the RAID being configured to flash the RAID light indicator and the first, second, and third activity light indicators when at least one of the first, second, and third slots in at least one of the trays is empty, the RAID being associated with and configured to flash the first availability light when the first slot is empty, the second availability light when the second slot is empty, and the third availability light when the third slot is empty.

### BACKGROUND OF THE INVENTION

1. Field of the Invention

The disclosure relates generally to a slot availability indication system, and more particularly to a slot availability indication system for hard disk drives.

2. Description of Background

In Storage Subsystems hard disk drives (HDDs) generally include two indicators; one amber indicator and one green indicator. The amber indicator is used to denote a fault condition, while the green indicator denotes general disk drive activity or usage. Most storage enclosures today package each HDD as a separate CRU/FRU (customer replaceable unit/field replaceable unit) and the two indicators are implemented accordingly. With the advent of Small Form Factor HDD technology (also referred to as 2.5″ disk drives), developers are beginning to package multiple HDDs within a single service boundary (CRU/FRU). This new packaging scheme creates difficulty when a user attempts to locate an empty disk drive slot within a multi-drive tray (MDT) to install a new HDD. This is because HDD's can be installed in depth in the MDT's, rendering it necessary for the user to remove MDT's from installation in order to locate empty drive space disposed behind occupied drive space. As such, a system for indicating available HDD space in an MDT is desirable.

### SUMMARY OF THE INVENTION

Disclosed is a slot availability indication system including a blade chassis defining a plurality of blade slots, a RAID controller disposed in at least one of the blade slots, a battery component disposed in at least one of the blade slots, at least one disk tray disposed in at least one of the blade slots, each of the at least one disk trays defining a first disk slot, a second disk slot, and a third disk slot disposed in depth, each of the first disk slot, the second disk slot, and the third disk slot being configured to contain a disk drive, and being logically associated with the RAID controller, a RAID light indicator disposed on the RAID controller, the RAID light indicator being logically associated with the first disk slot, the second disk slot, and the third disk slot of each of the at least one disk trays and the RAID controller, the RAID controller being logically configured to flash the RAID light indicator when at least one of the first disk slot, the second disk slot, and the third disk slot in at least one of the at least one disk trays is empty, a first disk activity light indicator disposed on each of the at least one disk trays, a second disk activity light indicator disposed on each of the at least one disk trays, and a third disk activity light indicator disposed on each of the at least one disk trays, wherein the RAID controller is logically associated with and configured to flash the first disk activity light, the second disk activity light, and the third disk activity light of any of the at least one trays in which at least one of the first disk slot, the second disk slot, and the third disk slot is empty, and a first disk availability light indicator disposed on each of the at least one disk trays, a second disk availability light indicator disposed on each of the at least one disk trays, and a third disk availability light indicator disposed on each of the at least one disk trays, wherein the RAID controller is logically associated with and configured to flash the first disk availability light when the first disk slot is empty light, the second disk availability light when the second disk slot is empty, and the third disk availability light when the third disk slot is empty.

Also disclosed is a method of indicating slot availability, the method including initiating available slot detection in a slot availability indication system via a user prompt, flashing at least one disk availability light indicator disposed on a disk tray and logically associated via a RAID controller with one of at least one empty slots in three disk slots defined by the disk tray, flashing three disk activity light indicators disposed on the disk tray and logically associated via the RAID controller with the three disk slots that include the at least one empty slot, and flashing a RAID light indicator disposed on the RAID controller and logically associated with the three disk slots that include the at least one empty slot.

### BRIEF DESCRIPTION OF THE DRAWINGS

The foregoing and other features and advantages of the present invention should be more fully understood from the following detailed description of illustrative embodiments taken in conjunction with the accompanying Figures in which like elements are numbered alike in the several Figures:

FIG. 1 is a side perspective of a schematic of a slot availability indication system;

FIG. 2 is a front view of the slot availability indication system;

FIG. 3 is a side perspective of a disk tray;

FIG. 4 is a schematic of the slot availability indication system in association with sub-system domains; and

FIG. 5 is a block diagram illustrating a method of indicating slot availability.

### DETAILED DESCRIPTION OF THE INVENTION

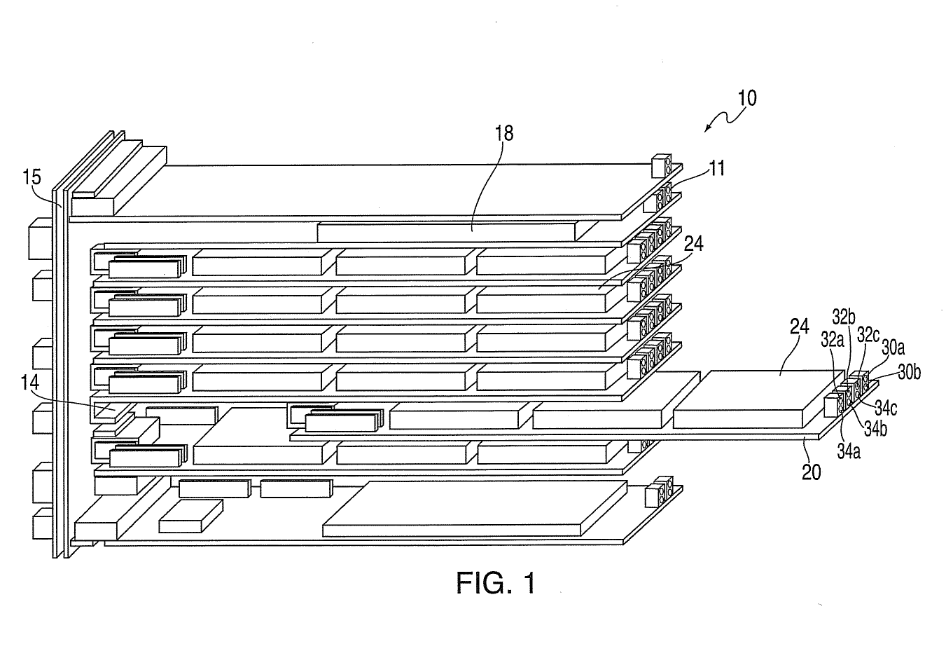

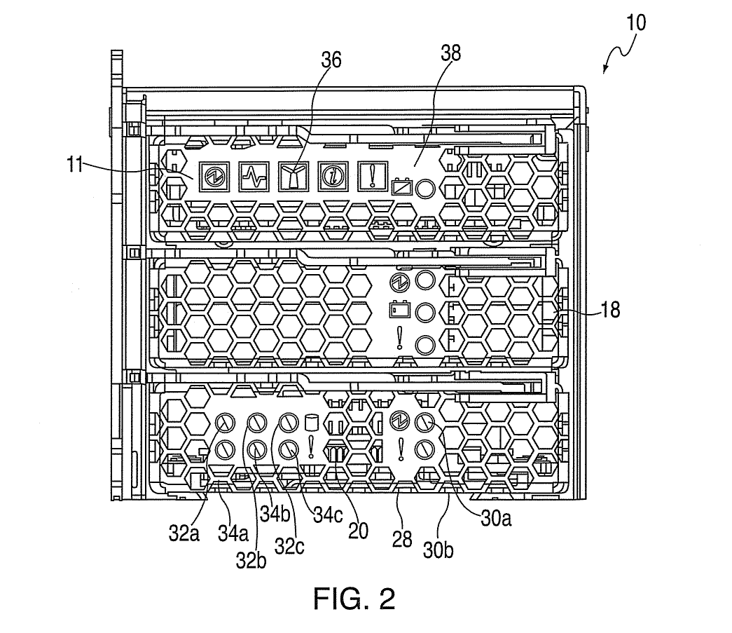

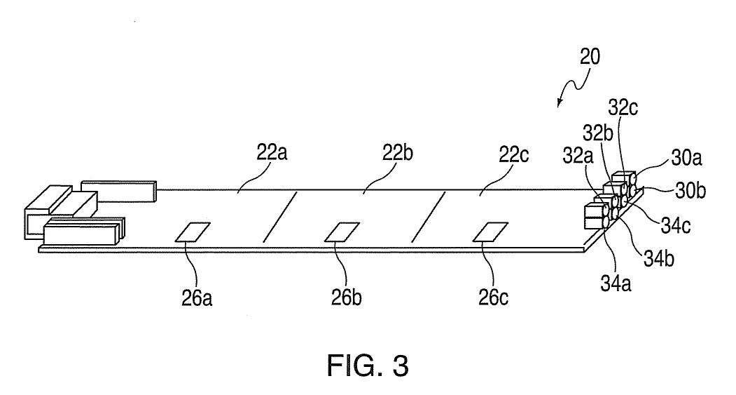

Referring to FIGS. 1, 2, and 3, a slot availability indication system 10 is illustrated. The system 10 includes a RAID (redundant array of independent disks) controller 11 disposed in one of a plurality of blade slots 14 defined by a blade chassis 15. RAID controllers, such as the RAID controller 11, typically combine multiple hard drives into a single logical unit, allowing an operating system to monitor several different hard drives as if it were one. As shown in FIGS. 1 and 2, the RAID controller 11 may be a server blade that includes a RAID logic card. As is also shown in FIGS. 1 and 2, the system 10 additionally includes a battery component 18 disposed in at least one of the blade slots 14, and at least one disk tray 20 disposed in at least one of the blade slots 14. These components, the elements of these components, and the manner in which they associate to comprise exemplary embodiments of the system 10 will be described hereinbelow, beginning with the disk trays 20 and their associations with the RAID controller 11.

Each of the disk trays 20 defines at least three disk slots (disposed in depth within the trays 20), illustrated as a first disk slot 22a, a second disk slot 22b, and a third disc slot 22c. Each of the disk slots 22a-c may contain a disk drive 24, and include a disk detection device 26a-c configured to detect whether the disk drive 24 it may contain is present within its respective disk slot. The disk detection devices 26a-c may be any type of detection device, such as a push button switch that may be depressed when one of the drives 24 is installed, or a pin on a disk drive connector (disposed on a surface of each slot 22a-c) that transmits a high signal when the slot(s) 22a-c are empty and a grounded/low signal when the disk slot(s) 22a-c contain a disk 24. The disk detection devices 26a-c logically associate the RAID controller 11 with the slots 22a-c they are respectively disposed in. When one or more of the disk slots 22a-c is empty (i.e. contains no disk drive 24), the disk detection devices 26a-c transmit a signal to the RAID controller 11 that indicates this emptiness. This allows the RAID controller 11 an awareness of what slots 22a-c (in what trays 20) are and are not empty. The RAID controller 11 is configured and programmed to indicate this awareness to a user via a series of flashable lights disposed on the RAID controller 11 and each disk tray 20.

Disposed on a surface 38 of the RAID controller 11 is a RAID light indicator 36. In addition, disposed on a surface 28 of each disk tray 20 are two tray light indicators 30a-b, a first, second, and third disk activity light indicators 32a-c, and a first, second, and third disk availability light indicators 34a-c. The light indicators, 32a-c and 34a-c are flashable, and logically associated with the RAID controller 11. These associations with the RAID controller 11 allow the first, second, and third disk activity light indicators 32a-c, and a first, second, and third disk availability light indicators 34a-c, to demonstrate conditions within the first, second, and third disk slots 22a-c respectively. When, for example, the disk detection device 26a transmits a signal to the RAID controller 11, and that signal indicates that the first disk slot 22a is empty, the RAID controller 11 flashes the lights, 32a-c and 34a-c on the surface 28 of the disk tray 20 in a manner that will alert a user of the empty slot 22a. In an exemplary embodiment, the lights, 32a-c and 34a-c are flashed as described hereinbelow, beginning with the RAID controller light 36.

Referring to the RAID light indicator 36, when at least one of the disk detection devices 26a-c in one of the trays 20 transmits a signal to the RAID controller 11 indicating that the slot 22a-c in which it resides is empty, the RAID controller 11 either lights or flashes (the lighting is typically blue) the RAID light indicator 36 disposed on its surface 38. Via this lighting or flashing, the user of the system 10 is made aware that at least one of the slots 22a-c in at least one of the disk trays 20 is empty. Thus, conveniently, the user need only view the RAID controller 11 to know that one or more of the disk slots 22a-c is empty. From there, the user can look to the trays 20 defining these slots 22a-c (and the lights 30a-b, 32a-c, and 34a-c disposed their surfaces 28) to determine which specific tray(s) 20 include the empty slot or slots 22a-c. Thus, via the system 10 as a whole, the user is made aware of slot 22a-c availability in the plurality of trays 20 without having to first remove any trays 20 from the chassis 15.

Referring to the activity light indicators 32a-c, when not indicating an empty slot, each of the disk activity light indicators 32a-c indicate (when lit) that the slot 20a-c it respectively corresponds with is receiving power. For example, when slot 22a is receiving power, the disk activity light indicator 32a is lit (the lighting is typically green). However, when the RAID controller 11 has been alerted (by one of the disk detection devices 26a-c) of an emptiness of at least one of the disk slots 22a-c in the tray 20, the RAID controller 11 transmits a signal to the disk activity light indicators 32a-c that instructs all three of the disk activity light indicators 32a-c to flash. Via this flashing, the user of the system 10 is further made aware that at least one of the slots 22a-c in this particular disk tray 20 is empty.

Similarly to the tray light indicator 30b, when not indicating an empty slot, each of the disk availability light indicators 34a-c indicate (when lit) that the slot 20a-c it respectively corresponds with is experiencing an error condition. For example, when slot 22a is experiencing an error condition, the disk availability light indicator 34a is lit (the lighting is typically amber). However, when the RAID controller 11 has been alerted of, for example, an emptiness in disk slot 22a, the RAID controller 11 transmits a signal to the disk availability light indicator 34a (corresponding to slot 22a) that instructs the disk availability light indicator 34a to flash. Via this flashing, the user of the system 10 is made aware that specific slot 22a in this particular disk tray 20 is empty. The RAID controller 11 similarly functions in conjunction with slots 22b-c (and their respective indicators 26b-c) and disk availability light indicators 34b-c when slots 22b-c are empty.

In an additional alternate embodiment, the light indicators 30a-b are also flashable and logically associated with the RAID controller 11 in a manner that will alert a user of at least one empty slot 22a-c. For example, when the RAID controller 11 has been alerted (by one of the disk detection devices 26a-c) of an emptiness of at least one of the disk slots 22a-c in the tray 20, the RAID controller 11 transmits a signal to the two tray light indicators 30a-b that instructs the two tray light indicators 30a-b to flash. Via this flashing, the user of the system 10 is made aware that at least one of the slots 22a-c in this particular disk tray 20 is empty. However, when not indicating an empty slot, one indicator 30a of the two tray light indicators 30a-b indicate (when lit) that the tray 20 is receiving power, while the other tray light indicator 30b indicates (when lit) that the tray 20 may be experiencing an error condition.

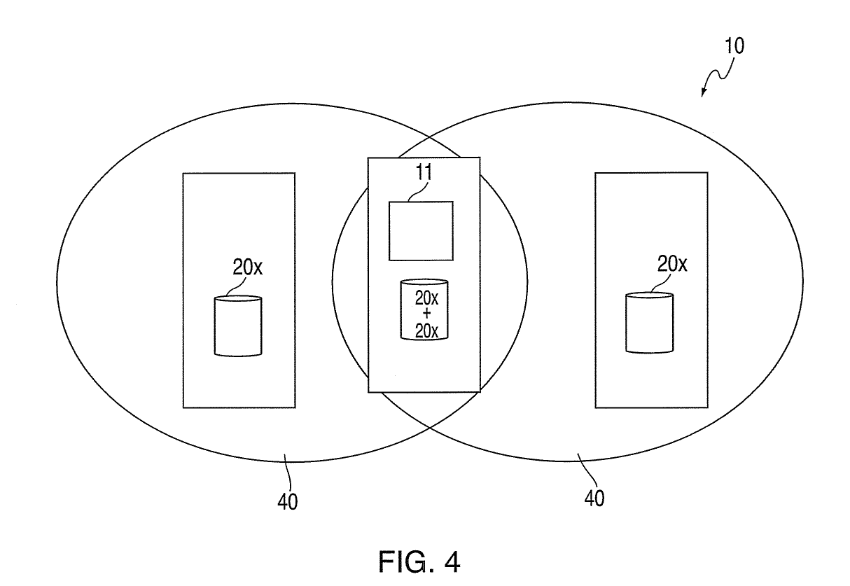

Referring to FIG. 4, it should be appreciated that the RAID controller 11 is logically associated with, and may be used by, at least one sub-system domain 40. Each sub-system domain 40 includes x-number of trays 20. Each of the x-number disk trays 20 that include the disk slots 20a-c logically associated with the RAID controller 11 are disposed in one of the at least one sub-system domains 40 logically associated with the RAID controller 11. Via these associations, a blinking/lit RAID light indicator 36 on the RAID controller 11 indicates to the user that at least one of the sub-system domains 40 associated with the RAID controller 11 includes an empty slot.

It should also be appreciated that though the RAID controller 11 may be configured to be consistently monitoring and aware of emptiness in any of the slots 22a-c (via the logical association with the disk detection device 26a-c), the RAID 11 will only flash the light indicators 36, 32a-c, and 34a-c (and optionally 30a-b) when the user/administrator instructs the RAID 11 to do so. Thus, the light indicators 36, 32a-c, and 34a-c (and optionally 30a-b) are only flashed upon initiation by the user/administrator. It should be further appreciated that each of the light indicators 36, 30a-c, 32a-c, and 34a-c may include bi-color capabilities.

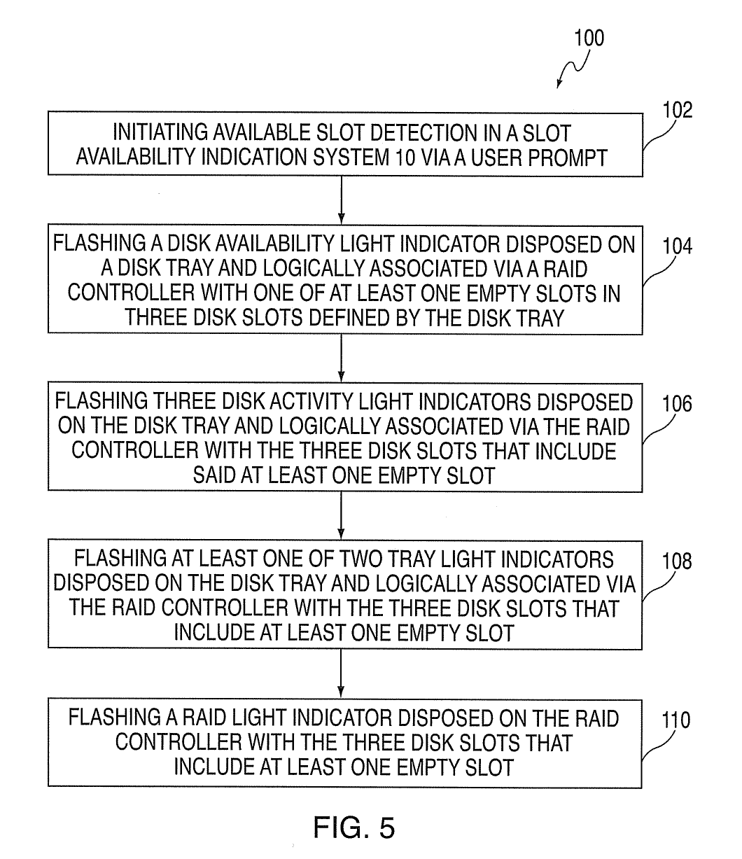

Referring to FIG. 5, a method 100 of indicating slot availability is illustrated and includes initiating available slot detection in a slot availability indication system 10 via a user prompt, as shown in operational block 102. The method also includes flashing a disk availability light indicator 34a-c disposed on a disk tray 20 and logically associated via a RAID controller 11 with one of at least one empty slots in three disk slots 22a-c defined by the disk tray 20, as is shown in operational block 104. The method 100 further includes flashing three disk activity light indicators 32a-c disposed on the disk tray 20 and logically associated via the RAID controller 11 with the three disk slots 22a-c that include the at least one empty slot, as shown in operational block 106. The method 100 additionally includes flashing at least one of two tray light indicators 30a-b disposed on the disk tray 20 and logically associated via the RAID controller 11 with the three disk slots 22a-c that include at least one empty slot, as shown in operational block 108. In addition, the method 100 includes flashing a RAID light indicator 36 disposed on the RAID controller 11 and logically associated with the three disk slots 22a-c that include at least one empty slot, as shown in operational block 110.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A slot availability indication system comprising:
a blade chassis defining a plurality of blade slots;
a RAID controller disposed in at least one of said blade slots;
a battery component disposed in at least one of said blade slots;
at least one disk tray disposed in at least one of said blade slots, each of said at least one disk trays defining a first disk slot, a second disk slot, and a third disk slot disposed in depth, each of said first disk slot, said second disk slot, and said third disk slot being configured to contain a disk drive, and being logically associated with said RAID controller;
a RAID light indicator disposed on said RAID controller, said RAID light indicator being logically associated with said first disk slot, said second disk slot, and said third disk slot of each of said at least one disk trays and said RAID controller, said RAID controller being logically configured to flash said RAID light indicator when at least one of said first disk slot, said second disk slot, and said third disk slot in at least one of said at least one disk trays is empty;
a first disk activity light indicator disposed on each of said at least one disk trays, a second disk activity light indicator disposed on each of said at least one disk trays, and a third disk activity light indicator disposed on each of said at least one disk trays, wherein said RAID controller is logically associated with and configured to flash said first disk activity light, said second disk activity light, and said third disk activity light of any of said at least one trays in which at least one of said first disk slot, said second disk slot, and said third disk slot is empty; and
a first disk availability light indicator disposed on each of said at least one disk trays, a second disk availability light indicator disposed on each of said at least one disk trays, and a third disk availability light indicator disposed on each of said at least one disk trays, wherein said RAID controller is logically associated with and configured to flash said first disk availability light when said first disk slot is empty light, said second disk availability light when said second disk slot is empty, and said third disk availability light when said third disk slot is empty.

2. The slot indication system of claim 1, wherein said at least one disk tray is disposed within a storage sub-system domain.

3. The slot indication system of claim 1, wherein said RAID controller is logically associated with at least one storage sub-system domain, and wherein each of said at least one disk trays including said disk slots that are logically associated with said RAID controller are disposed in one of said at least one sub-systems logically associated with said RAID controller.

4. The slot indication system of claim 1, wherein each of said first disk slot, said second disk slot, and said third disk slot each include a disk detection device configured to detect presence of said disk drive.

5. The slot indication system of claim 4, wherein said disk detection devices are logically associated with said RAID controller.

6. The slot indication system of claim 1, further including two tray light indicators disposed on each of said at least one disk trays, said two light indicators being logically associated with said RAID controller, said RAID controller being logically configured to flash at least one of said two tray light indicators disposed on any of said at least one trays in which at least one of said first disk slot, said second disk slot, and said third disk slot is empty.

7. The slot indication system of claim 6, wherein said a RAID light indicator, said first disk activity light, said second disk activity light, and said third disk activity light, said first disk availability light, said second disk availability light, and said third disk availability light, and said two light indicators are each configured to be bi-color.

8. A method of indicating slot availability, the method comprising:
initiating available slot detection in a slot availability indication system via a user prompt;
flashing at least one disk availability light indicator disposed on a disk tray and logically associated via a RAID controller with one of at least one empty slots in three disk slots defined by said disk tray;
flashing three disk activity light indicators disposed on said disk tray and logically associated via said RAID controller with said three disk slots that include said at least one empty slot; and
flashing a RAID light indicator disposed on said RAID controller and logically associated with said three disk slots that include said at least one empty slot.

9. The method of claim 7, further including flashing at least one of two tray light indicators disposed on said disk tray and logically associated via said RAID controller with said three disk slots that include said at least one empty slot.
